(19) United States
(12) Patent Application Publication
(10) Pub. No.: US 2020/0372823 A1
(43) Pub. Date: Nov. 26, 2020

(54) Systems and Methods for Interactive Learning through a Graphical User Interface

(71) Applicant: Capital One Services, LLC, McLean, VA (US)

(72) Inventors: Joshua Edwards, Philadelphia, PA (US); Michael Mossoba, Arlington, VA (US); Abdelkader M'Hamed Benkreira, New York, NY (US)

(73) Assignee: Capital One Services, LLC, McLean, VA (US)

(21) Appl. No.: 16/420,777

(22) Filed: May 23, 2019

(51) Int. Cl. G09B 19/00; G06Q 40/00

(52) U.S. Cl. CPC G09B 19/00; G06Q 40/12

(57) ABSTRACT

Embodiments disclosed herein generally related to a system and method for generating a dynamic graphical user interface (GUI). The system identifies at least one financial goal of the user. The system generates a target savings amount for the at least one financial goal based at least on one or more spending habits of the user. The system generates a GUI. The GUI includes at least one gamification element corresponding to the at least one financial goal. The at least one gamification element visually depicts progress towards the savings amount. The system receives at least one account event. The system updates the GUI by adjusting the gamification element to depict an updated progress towards the savings amount.

### FIELD OF THE DISCLOSURE

The present disclosure generally relates to a method and a system for generating a dynamic graphical user interface.

### BACKGROUND

It is typically difficult for individuals to learn and understand financial principles. For example, it is often difficult for individuals to envision funds entering and leaving an individual's account and how the plurality of account debits and/or credits affect future spending habits. Conventional approaches to providing users with such information is limited to traditional ledger formats, in which users are merely provided with a list of account debits and account credits. While the traditional ledger may include information that is vital to a user's account, such information may be useless for individuals with less financial savvy.

### SUMMARY

Embodiments disclosed herein are generally related to a system and method for generating a dynamic graphical user interface. In some embodiments, an account management system is disclosed herein. The account management system comprises a processor and a memory. The processor is in communication with a client device of a user. The memory has programming instructions stored thereon, which, when executed by the processor performs an operation. The operation includes identifying at least one financial goal of the user. The operation further includes generating a target savings amount for the at least one financial goal based at least on one or more spending habits of the user. The operation further includes generating a graphical user interface (GUI). The GUI includes at least one gamification element corresponding to the at least one financial goal. The at least one gamification element visually depicts progress towards the savings amount. The operation further includes receiving at least one account event. The operation further includes updating the GUI by adjusting the gamification element to depict an updated progress towards the savings amount.

In some embodiments, the operation of identifying at least one financial goal of the user includes receiving, from the client device, the at least one financial goal of the user.

In some embodiments, the operation of identifying at least one financial goal of the user includes analyzing one or more accounts of the user to identify one or more transactions, identifying at least one product or service for which the user has transacted above a threshold number of times, and setting the at least one product or service as the target savings amount.

In some embodiments, the at least one gamification element comprises a progress bar.

In some embodiments, the operation of generating the target savings amount for the at least one financial goal based on the at least one or more spending habits of the user includes identifying at least one or more spending habits of one or more other users and adjusting the target savings amount based on the at least one or more spending habits of one or more other users.

In some embodiments, generating the target savings amount for the at least one financial goal based on the at least one or more spending habits of the user includes identifying a total cost associated with the at least one financial goal from one or more external data sources.

In some embodiments, the operation further includes generating a recommendation message based on the received at least one transaction event and transmitting the recommendation message to the client device of the user.

In some embodiments, the received at least one transaction event includes at least one of a debit from the user's account or a credit to the user's account.

In some embodiments, the gamification element includes one or more sub-elements representative of one or more categories of spending associated with the financial goal.

In another embodiment, a method of generating a dynamic graphical user interface is disclosed herein. A computing system receives, from a client, an indication of at least one financial goal of the user. The computing system identifies one or more categories of spending associated with the financial goal. The computing system generates a target savings amount for the at least one financial goal based at least on one or more spending habits of the user. The target savings amount includes a category-level target savings amount for each of the one or more categories of spending. The computing system generates a graphical user interface (GUI). The GUI includes at least one gamification element corresponding to the at least one financial goal. The at least one gamification element visually depicts progress towards the savings amount. The computing system receives, from at least one third party computing system, at least one account event. The computing system updates the GUI by adjusting the gamification element to depict an updated progress towards the savings amount.

In some embodiments, the computing system generating the GUI that includes the at least one gamification element corresponding to the at least one financial goal includes the computing system generating at least one progress bar associated with the at least one gamification element.

In some embodiments, the computing system generating at least one progress bar associated with the at least one gamification element includes the computing system generating one or more category-level progress bars. Each category-level progress bar corresponds to a category-level target savings amount.

In some embodiments, the computing system generating the target savings amount for the at least one financial goal based on the at least one or more spending habits of the user includes the computing system identifying at least one or more spending habits of one or more other users and adjusting the target savings amount based on the at least one or more spending habits of one or more other users.

In some embodiments, the computing system generating the target savings amount for the at least one financial goal based on the at least one or more spending habits of the user includes the computing system identifying a total cost associated with the at least one financial goal from one or more external data sources.

In some embodiments, the computing system further generates a recommendation message based on the received at least one transaction events. The computing system further transmits the recommendation message to the client.

In some embodiments, the received at least one transaction event includes at least one of a debit from the user's account or a credit to the user's account.

In another embodiment, a non-transitory computer readable medium is disclosed herein. The non-transitory computer readable medium includes one or more sequences of instructions, which, when executed by one or more processors, cause the one or more processors to perform operations. The operations include parsing a transaction history of the user to identify at least one financial goal of the user. The operations further include generating a target savings amount for the at least one financial goal based at least on one or more spending habits of the user. The operations further include generating a graphical user interface (GUI). The GUI includes at least one gamification element corresponding to the at least one financial goal. The at least one gamification element visually depicts progress towards the savings amount. The operation further includes receiving at least one account event. The operation further includes updating the GUI by adjusting the gamification element to depict an updated progress towards the savings amount.

In some embodiments, the operation of parsing the transaction history of the user to identify the at least one financial goal of the user comprises includes identifying at least one product or service for which the user has transacted above a threshold number of times.

In some embodiments, the operation of generating the target savings amount for the at least one financial goal based on the at least one or more spending habits of the user includes identifying at least one or more spending habits of one or more other users and adjusting the target savings amount based on the at least one or more spending habits of one or more other users.

In some embodiments, the operation of generating the target savings amount for the at least one financial goal based on the at least one or more spending habits of the user includes identifying a total cost associated with the at least one financial goal from one or more external data sources.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to one exemplary embodiment.

FIG. 2 is a flow diagram illustrating a method of generating a dynamic graphical user interface, according to one exemplary embodiment.

FIG. 3 is a flow diagram illustrating a method of generating a dynamic graphical user interface, according to one exemplary embodiment.

FIG. 4 is a flow diagram illustrating a method of generating a dynamic graphical user interface, according to one exemplary embodiment.

FIG. 5A is a block diagram illustrating a graphical user interface displayed on a client device, according to one exemplary embodiment.

FIG. 5B is a block diagram illustrating a graphical user interface displayed on a client device, according to one exemplary embodiment.

FIG. 6 is a block diagram illustrating a computing environment, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

One or more techniques disclosed herein are generally directed to a method and a system for generating a dynamic graphical user interface (GUI). In particular, the one or more techniques disclosed herein generally relate to generating a dynamic GUI that includes one or more gamification elements that attempt to convey financial principles to end users. For example, the one or more gamification elements may include one or more financial goals for an end user. In some embodiments, one or more financial goals may be explicitly provided by end users to the system. In some embodiments, one or more financial goals may be implicitly identified by the system by analyzing one or more spending habits of the user. Each gamification element may correspond to a particular financial goal and provide users with a visual representation an amount of funds it would take to achieve such a financial goal.

The one or more techniques disclosed herein may dynamically update the GUI based on a live feed of debits and credits in the user's account. For example, based on live spending information, the system may dynamically update the one or more gamification elements to visually illustrate the impact such spending has on the user's financial goals. In some embodiments, the system may provide one or more recommendations to the user in an attempt to foster better spending habits. For example, the system may notify the user that if the user stopped buying coffee every day from the corner coffee shop, the user may achieve a financial goal faster than initially expected.

The term “user” as used herein includes, for example, a person or entity that owns a computing device or wireless device; a person or entity that operates or utilizes a computing device; or a person or entity that is otherwise associated with a computing device or wireless device. It is contemplated that the term “user” is not intended to be limiting and may include various examples beyond those described.

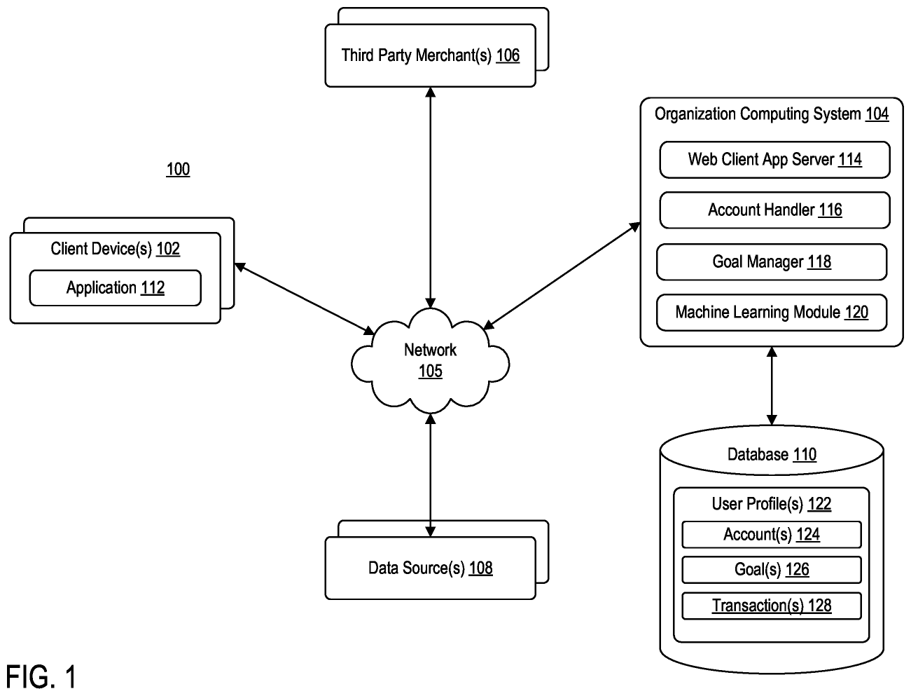

FIG. 1 is a block diagram illustrating a computing environment 100, according to one embodiment. Computing environment 100 may include at least one or more client devices 102, an organization computing system 104, and one or more third party merchants 106, and one or more data sources 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™ ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may include any type of computer networking arrangement used to exchange information. For example, network 105 may be the Internet, a private data network, a virtual private network using a public network and/or other suitable connection(s) that enables components in computing environment 100 to send and receiving information between the components of system 100.

Client device 102 may be operated by a user (or customer). For example, client device 102 may be a mobile device, a tablet, a desktop computer, or any computing system having the capabilities described herein. Client device 102 may belong to or be provided to a customer (e.g., user 101) or may be borrowed, rented, or shared. Customers may include individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 102 may include at least application 112. Application 112 may be representative of a web browser that allows access to a website or a stand-alone application. Client device 102 may access application 112 to access functionality of organization computing system 104. Client device 102 may communicate over network 105 to request a webpage, for example, from web client application server 114 of organization computing system 104. For example, client device 102 may be configured to execute application 112 to access content managed by web client application server 114. The content that is displayed to client device 102 may be transmitted from web client application server 114 to client device 102, and subsequently processed by application 112 for display through a graphical user interface (GUI) of client device 102.

Organization computing system 104 may include at least web client application server 114, an account handler 116, a goal manager 118, and a machine learning module 120. Each of account handler 116, goal manager 118, and machine learning module 120 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather as a result of instructions.

Goal manager 118 may be configured to identify and manage one or more financial goals of each user. In some embodiments, goal manager 118 may identify one or more financial goals of a user through an explicit conveyance of the financial goal from client device 102 to organization computing system 104. For example, a user of client device 102 may submit a financial goal to organization computing system 104 via application 112 executing thereon, such that the financial goal may be stored in a corresponding user profile. In some embodiments, goal manager 118 may identify one or more financial goals of a user implicitly, through an analysis of the user's transaction history. For example, goal manager 118 may leverage a machine learning algorithm trained by machine learning module 120 to identify one or more products and/or services the user typically purchases. Through this analysis, goal manager 118 may identify one or more products and/or services and set a financial goal for each of the one or more products or services.

Generally, a financial goal may be referred to as a target amount of money that is to be reached to afford the product and/or service represented by the financial goal. Exemplary financial goals may include, for example, a trip to Japan, tickets to a soccer match, tickets to a concert, a new car, a new sweater, and the like. The target savings amount may be determined by goal manager 118 using a machine learning model generated by machine learning module 120. For example, goal manager 118 may generate the target savings amount for the financial goal based on one or more spending habits of the user. Goal manager 118 may parse through the transaction history of the user to identify how the user manages his or her money to determine both a monetary amount associated with the financial goal and an estimated timeline for when the user will reach the monetary amount. Using a specific example, goal manager 118 may determine that the user typically buys tickets for one football game per year. Goal manager 118 may set a target savings amount to achieve to buy tickets for the football game. Goal manager 118 may also estimate how long it will take the user to achieve this amount based on other transactions of the user. For example, even though the user may have enough money in his or her account afford the tickets, goal manager 118, by analyzing spending habits of the user, may determine that it will take the user three months to achieve the target savings amount based on his or her pattern of spending.

In some embodiments, goal manager 118 may communicate with one or more external data sources 108 to determine the target savings amount for a financial goal. Each external data source 108 may be representative of one or more computing systems that may host price data associated with one or more products and/or services. Goal manager 118 may reference one or more external data sources 108 to better determine the target savings amount for a financial goal. Continuing with the above example, to determine a price associated with football tickets, goal manager 118 may perform an analysis on tickets sales across the football league to determine average ticket prices for a football game.

In some embodiments, goal manager 118 may take into consideration all costs associated with a particular financial goal. Continuing with the above example, not only may goal manager 118 identify a cost of admission associated with the football game, goal manager 118 may consider other costs, such as, but not limited to average cost of concessions, average cost of transportation, and the like. Goal manager 118 may adjust the savings goal based on one or more spending habits of the user. For example, goal manager 118 may determine that the user has frequent transactions at dining establishments. Accordingly, goal manager 118 may determine that there is a high likelihood that the user will purchase one or more concessions at the football game. Accordingly, goal manager 118 may update the target savings amount accordingly. Still further, goal manager 118 may explicitly allocate portions of the total target savings amount to one or more sub-components.

After goal manager 118 generates a target savings amount for a financial goal, goal manager 118 may generate a GUI that includes one or more gamification elements corresponding to the financial goal. The gamification element may visually depict a financial goal along with a target savings amount for the financial goal. For example, the gamification element may include a first graphical element indicating the financial goal itself, and a second graphical element depicting a progress bar that tracks the user's progress of reaching the target savings amount.

In some embodiments, similar to how goal manager 118 may explicitly allocate portions of the total target savings amount to one or more sub-components, goal manager 118 may generate one or more graphical elements visually depicting each sub-component and the progress thereof. Goal manager 118 may transmit the GUI to client device 102 for rendering and display.

Machine learning module 120 may include one or more computer systems configured to train a prediction model used by goal manager 118. To train the prediction model, machine learning module 120 may receive, as input, one or more streams of user activity. The one or more streams of user activity may correspond to actions taken by the user with respect to the user's accounts with organization computing system 104. Such streams of activity may include historical transaction data of the user, as well as, accounts payment, navigation of web pages, calls to customer service, chat sessions with a bot, interactions with emails from organization computing system 104, and the like. In some embodiments, machine learning module 120 may further receive, as input, one or more streams of activity associated with additional users (e.g., users similar to the current user based on). As such, machine learning module 120 may leverage both user specific and user agnostic information to identify a particular financial goal and a cost associated with that financial goal. Machine learning module 120 may implement one or more machine learning algorithms to train the prediction model. For example, machine learning module 120 may use one or more of a decision tree learning model, association rule learning model, artificial neural network model, deep learning model, inductive logic programming model, support vector machine model, clustering model, Bayesian network model, reinforcement learning model, representational learning model, similarity and metric learning model, rule based machine learning model, and the like.

Account handler 116 may be configured to manage a profile associated with each user. For example, account handler 116 may be configured to communicate with database 110. As illustrated, database 110 may include one or more user profiles 122.

Each user profile 122 may correspond to a respective user of the organization associated with organization computing system 104. Each user profile 122 may include one or more accounts 124, one or more financial goals 126, and one or more transactions 128. Each account 124 may correspond to a respective financial account with the organization. For example, within user profile 122 may be one or more credit card accounts and one or more debit card accounts. Financial goals 126 may be representative of one or more financial goals identified by goal manager 118. For example, financial goals 126 may be representative of one or more explicit financial goals (i.e., those explicitly conveyed by the user) and one or more implicit financial goals (i.e., those identified by goal manager 118). One or more transactions 128 may be representative of one or more transactions that occurred across the user's account. For example, one or more transactions 128 may stem from one or more third party merchants 106.

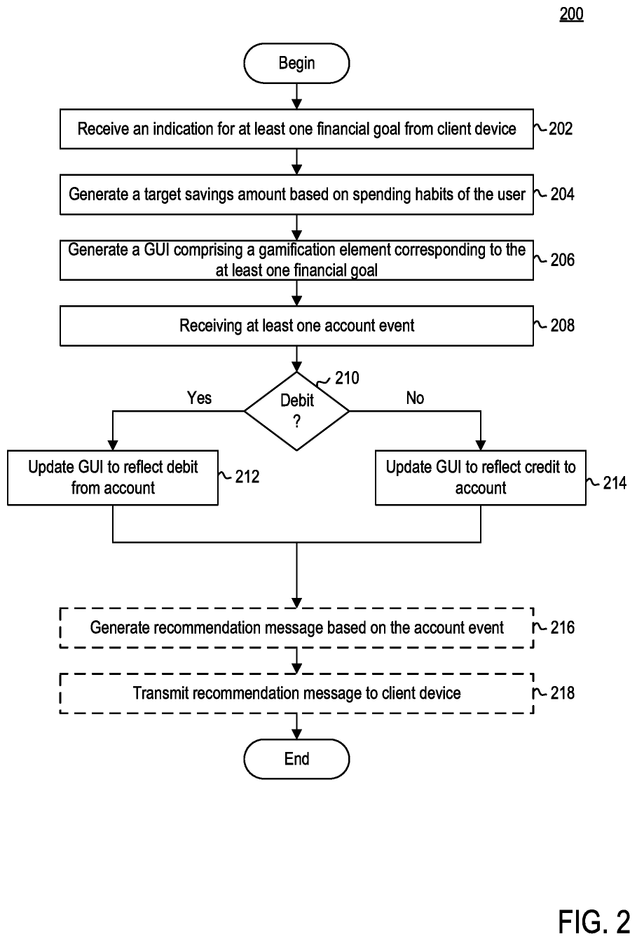

FIG. 2 is a flow diagram illustrating a method 200 of generating a dynamic graphical user interface (GUI), according to example embodiments. For example, the dynamic GUI may be generated by organization computing system 104, transmitted to client device 102 and rendered and displayed via client device 102. Method 200 may begin at step 202.

At step 202, organization computing system 104 may receive an indication of one or more financial goals of a user of client device 102. In some embodiments, organization computing system 104 may receive an express indication of a financial goal from client device 102. For example, organization computing system 104 may receive a product, service, experience, etc., for which the user wants to save. For example, in some embodiments, organization computing system 104 may generate one or more GUIs that allow a user to input one or more financial goals. In some embodiments, GUI may include a tiered system, in which a user may first select what kind of thing they are saving for (e.g., “Travel”, “Big Purchase”, “Event”, etc.). From there, the user would receive a subset of options (e.g., searchable options). For example, if the user selected “Travel,” the user may type into the box where their desired destination (e.g., “Tokyo,” “Japan,” “Milwaukee,” etc.). In another example, under “Big Purchase,” the user may select “fridge” or “PS4”. The search would use the basics of NLP (e.g., synonym matching) to translate customer's input into a format organization computing system 104 may recognize and for which organization computing system 104 may receive pricing information.

In some embodiments, rather than a tiered system, one or more GUIs may include graphical elements. For example, the initial set of options presented to the user may be images. If a user clicked on an airplane picture, the GUI may update to display an interactive map, prompting the user to select a location for travel. In another example, if the user selected an image corresponding to “Event” (e.g., a football picture), the GUI may update to display various images, such as, but not limited to, a football, soccer ball, golf clubs, microphone, etc.

In some embodiments, organization computing system 104 may generate a GUI that includes an input field for a uniform resource locator (URL). The URL may correspond to an item the user wishes to purchase (e.g., an Amazon link to a gaming console, a StubHub link to a football game, etc.). From there, organization computing system 104 may perform a data mining routine on the webpage to determine the item the user wishes to purchase, the cost associated therewith, an image of the item, and the like. In some embodiments, the GUI may include an upload field for the user to upload an image of the item they wish to purchase. Organization computing system 104 may then use image recognition to translate the captured image into an actual product and search various webpages for the price of the item.

In some embodiments, organization computing system 104 may identify one or more financial goals of the user by analyzing a transaction history associated with the user. For example, organization computing system 104 may leverage a machine learning algorithm, trained by machine learning module 120, to identify a financial goal of the user by providing, as input to the machine learning algorithm, one or more transactions (e.g., transactions 128) of the user. Accordingly, goal manager 118 may prompt the user with one or more potential financial goals based on a spending history of the user.

At step 204, organization computing system 104 may generate a target savings amount for each of the one or more financial goals based on one or more spending habits of the user. For example, goal manager 118 may provide, as input, to a machine learning algorithm, trained by machine learning module 120, one or more transactions 128 of the user. Accordingly, goal manager 118 may receive, as output, from the machine learning algorithm, an identification of one or more spending habits of the user. Such exemplary spending habits may include, but are not limited to, a user transacting most frequently at coffee shops, a user typically using ride share vehicles as transportation, a user typically splurging once per week at a restaurant, using a debit card with no reward points versus a credit card with reward points, recurring charges that the user may consider cancelling or reducing (e.g., streaming services), merchant categories in which the user spends higher than average for their location, behavioral spending patterns/habits (e.g., weekly visits to the shopping mall, frequency of dining out, frequency of using ride-share applications, etc.), a product/service the user transacted at least a threshold number of times, and the like.

At step 206, organization computing system 104 may generate a GUI that includes at least one gamification element corresponding to the identified one or more financial goals of the user. The at least one gamification element may be used to provide an interactive experience with the user of client device 102, in an attempt to foster improved financial habits. For example, by providing the at least one gamification element, a user of client device 102 may be able to view progress associated with reaching a financial goal, in an attempt to show the user how improved savings habits can streamline a savings experience. The at least one gamification element may include at least one graphical element corresponding to the target of the financial goal (e.g., trip, one or more goods, one or more services, etc.) and at least a second graphical element corresponding to a user's progress towards satisfying that financial goal (e.g., progress bar of the financial goal). As a user's account receives debit account events (i.e., money leaving the account) and credit account events (i.e., money entering the account), the progress bar may dynamically change, thereby providing real-time (or near real-time) status changes of the financial goal.

At step 208, organization computing system 104 may receive at least one account event associated with an account 124 from user profile 122. For example, organization computing system 104 may receive at least one of a credit account event or a debit account event. At step 210, organization computing system 104 may determine if the account event is a debit account event. For example, goal manager 118 may receive a debit account event from a third party merchant 106.

If, at step 210, organization computing system 104 determines that the account event is a debit account event, then method 200 proceeds to step 212. At step 212, organization computing system 104 may update the GUI to reflect the debit account event. For example, based on the amount of money leaving the user's account, goal manager 118 update the gamification element accordingly. In some embodiments, updating the gamification element may include updating the graphical element reflecting the progress based on the debit account event. In some embodiments, updating the gamification element may include maintaining the current state of the progress bar.

If, however, at step 210, organization computing system 104 determines that the account event is not a debit account event (i.e., the account event is a credit account event), then method 200 proceeds to step 214. At step 214, organization computing system 104 may update the GUI to reflect the credit account event. For example, based on the amount of money entering the user's account (e.g., salary deposit), goal manager 118 may update the gamification element accordingly. In some embodiments, updating the gamification element may include updating the graphical element reflecting the progress based on the credit account event. Although a credit account event corresponds to money entering the user's account, those skilled in the art may readily understand that not all credit account events may result in the user's progression towards a financial goal.

In some embodiments, method 200 may further include step 216 and step 218. At step 216, organization computing system 104 may generate a recommendation message based on the account event received at step 208. For example, assuming the account event is a debit account event, goal manager 104 may generate a message that notifies the user that continuing along this spending habit may elongate the time it takes to reach the financial goal by a determined amount of time. In another example, assuming the account event is a credit account event, goal manager 118 may generate a message that notifies the user that continuing along this path of savings versus spending may allow the user to reach the financial goal quicker than initially estimated.

At step 218, organization computing system 104 may transmit the recommendation message to client device 102. For example, organization computing system 104 may transmit the recommendation message to client device 102 via application 112 executing thereon. Application 112 may render and cause a display associated with client device 102 to display the message.

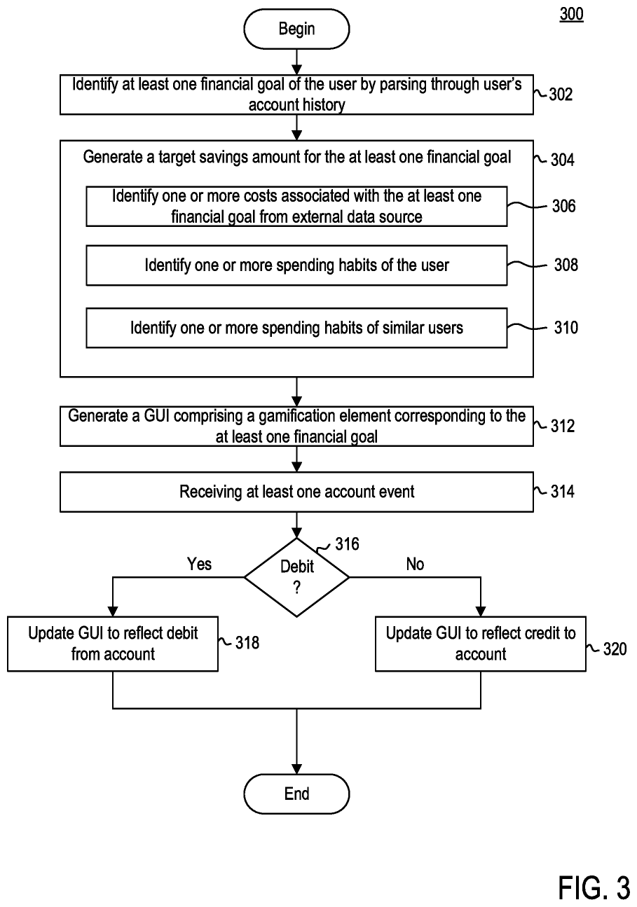

FIG. 3 is a flow diagram illustrating a method 300 of generating a dynamic GUI, according to example embodiments. The dynamic GUI may be generated by organization computing system 104 and transmitted to client device 102 for rendering and display. Method 300 may begin at step 302.

At step 302, organization computing system 104 may identify at least one financial goal of the user by parsing through the user's account history to receive an indication of one or more financial goals of a user of client device 102. For example, goal manager 118 may identify one or more financial goals of the user by analyzing a transaction history associated with the user. In some embodiments, organization computing system 104 may leverage a machine learning algorithm, trained by machine learning module 120, to identify a financial goal of the user by providing, as input to the machine learning algorithm, one or more transactions (e.g., transactions 128) of the user. Accordingly, goal manager 118 may prompt the user with one or more potential financial goals based on a spending history of the user.

At step 304, organization computing system 104 may generate a target savings amount for each of the one or more financial goals. Step 304 may include one or more sub-steps 306-310. At sub-step 306, organization computing system 104 may identify one or more costs associated with the at least one financial goal from one or more external data sources 108. For example, goal manager 118 may receive live price data from one or more external data sources 108 in generating the target savings amount. In a specific example, goal manager 118 may identify an average cost, median price, and/or range of prices for an airline flight and hotel accommodations, assuming the financial goal is a vacation. In this example, goal manager 118 may request price information from one or more airline or hotel booking websites.

At sub-step 308, organization computing system 104 may identify one or more spending habits of the user. For example, goal manager 118 may provide, as input, to a machine learning algorithm, trained by machine learning module 120, one or more transactions 128 of the user. Accordingly, goal manager 118 may receive, as output, from the machine learning algorithm, an identification of one or more spending habits of the user. Such exemplary spending habits may include, but are not limited to, a user transacting most frequently at coffee shops, a user typically using ride share vehicles as transportation, a user typically splurging once per week at a restaurant, and the like.

At sub-step 310, organization computing system 104 may analyze one or more spending habits of other users. For example, goal manager 118 may identify one or more users that are similar to the current user. A similar user may be defined by a user sharing one or more traits with another user (e.g., date of birth, geographical location, salary information, savings information, education level, and the like). Goal manager 118 may provide, as input, to the machine learning algorithm, trained by machine learning module 120, one or more transactions 128 of the other users (e.g., in addition to the one or more transactions 128 of the current user). Accordingly, goal manager 118 may receive, as output, from the machine learning algorithm, an identification of one or more spending habits of similar users. Goal manager 118 may use this information to generate or build a profile of the user's spending habits of the user compared to other users. For example, goal manager 118 may identify that the customer goes to restaurants more (or less) than other customers, whether the customer on average spends more (or less) when they go to restaurants, whether they spend more or less when attending previous events (such as concerts and football games), whether they tend to spend more or less on airplane tickets, behavioral spending patterns/habits (e.g., weekly visits to the shopping mall, frequency of dining out, frequency of using ride-share applications, etc.), and the like. This information may be used, for example, to determine that when the user goes to Japan, although the historical range of food costs in Japan is between about $20-$300/day, and the median value is about $70/day, because the user spends less than the average user on food, goal manager 118 can predict that the user will only spend about $60/day compared to the $70/day median.

At step 312, organization computing system 104 may generate a GUI that includes at least one gamification element corresponding to the identified one or more financial goals of the user. The at least one gamification element may be used to provide an interactive experience with the user of client device 102, in an attempt to foster improved financial habits. For example, by providing the at least one gamification element, a user of client device 102 may be able to view progress associated with reaching a financial goal, in an attempt to show the user how improved savings habits can streamline a savings experience. In another example, the GUI may allow the user to adjust financial goals, by showing the calculations to the user. For instance, a GUI may include data about average cost for food in Japan. Users can indicate, via GUI, that on vacation they splurge, so they may update calculations to be based off $100/day instead of $60/day. The at least one gamification element may include at least one graphical element corresponding to the target of the financial goal (e.g., trip, one or more goods, one or more services, etc.) and at least a second graphical element corresponding to a user's progress towards satisfying that financial goal (e.g., progress bar of the financial goal). As a user's account receives debit account events (i.e., money leaving the account) and credit account events (i.e., money entering the account), the progress bar may dynamically change, thereby providing real-time (or near real-time) status changes of the financial goal.

At step 314, organization computing system 104 may receive at least one account event associated with an account 124 from user profile 122. For example, organization computing system 104 may receive at least one of a credit account event or a debit account event. At step 316, organization computing system 104 may determine if the account event is a debit account event. For example, goal manager 118 may receive a debit account event from a third party merchant 106.

If, at step 316, organization computing system 104 determines that the account event is a debit account event, then method 300 proceeds to step 318. At step 318, organization computing system 104 may update the GUI to reflect the debit account event. For example, based on the amount of money leaving the user's account, goal manager 118 may update the gamification element accordingly. In some embodiments, updating the gamification element may include updating the graphical element reflecting the progress based on the debit account event. In some embodiments, updating the gamification element may include maintaining the current state of the progress bar.

If, however, at step 316, organization computing system 104 determines that the account event is not a debit account event (i.e., the account event is a credit account event), then method 300 proceeds to step 320. At step 320, organization computing system 104 may update the GUI to reflect the credit account event. For example, based on the amount of money entering the user's account (e.g., salary deposit), goal manager 118 may update the gamification element accordingly. In some embodiments, updating the gamification element may include updating the graphical element reflecting the progress based on the credit account event. Although a credit account event corresponds to money entering the user's account, those skilled in the art may readily understand that not all credit account events may result in the user's progression towards a financial goal.

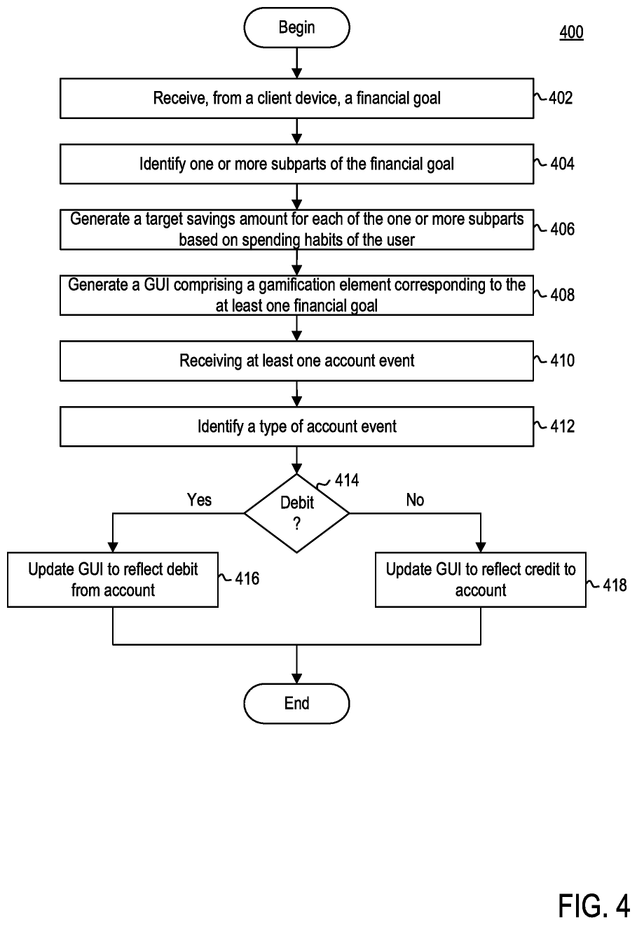

FIG. 4 is a flow diagram illustrating a method 400 of generating a dynamic graphical user interface (GUI), according to example embodiments. For example, the dynamic GUI may be generated by organization computing system 104, transmitted to client device 102 and rendered and displayed via client device 102. Method 400 may begin at step 402.

At step 402, organization computing system 104 may receive an indication of one or more financial goals of a user of client device 102. In some embodiments, organization computing system 104 may receive an express indication of a financial goal from client device 102. For example, organization computing system 104 may receive a product, service, experience, etc., for which the user wants to save. In some embodiments, organization computing system 104 may identify one or more financial goals of the user by analyzing a transaction history associated with the user. For example, organization computing system 104 may leverage a machine learning algorithm, trained by machine learning module 120, to identify a financial goal of the user by providing, as input to the machine learning algorithm, one or more transactions (e.g., transactions 128) of the user. Accordingly, goal manager 118 may prompt the user with one or more potential financial goals based on a spending history of the user.

At step 404, organization computing system 104 may identify one or more subparts of the identified financial goal of the user. For example, goal manager 118 may consider one or more subparts of each identified financial goal. Such subparts may include, but are not limited to, all costs associated with the financial goal. In a specific example, assume that the identified financial goal is tickets to a football game. Goal manager 118 may explicitly define all costs associated with the football game. Such costs may include, but are not limited to, price of the tickets, price of concessions, price of transportation to and from the game, price of parking, and the like.

At step 406, organization computing system 104 may generate a target savings amount for each of the one or more financial goals based on one or more spending habits of the user. For example, goal manager 118 may provide, as input, to a machine learning algorithm, trained by machine learning module 120, one or more transactions 128 of the user. Accordingly, goal manager 118 may receive, as output, from the machine learning algorithm, an identification of one or more spending habits of the user. Such exemplary spending habits may include, but are not limited to, a user transacting most frequently at coffee shops, a user typically using ride share vehicles as transportation, a user typically splurging once per week at a restaurant, using a debit card with no reward points versus a credit card with reward points, recurring charges that the user may consider cancelling or reducing (e.g., streaming services), merchant categories in which the user spends higher than average for their location, behavioral spending patterns/habits (e.g., weekly visits to the shopping mall, frequency of dining out, frequency of using ride-share applications, etc.), and the like. In some embodiments, goal manager 118 may provide a target savings amount for each sub-part of the financial goal. Continuing with the above example, goal manager 118 may define a total target savings amount of a football game for $500, and divide that $500 among tickets (e.g., $250), concessions (e.g., $125), transportation (e.g., $100), parking (e.g., $0), and the like (e.g., $25).

At step 408, organization computing system 104 may generate a GUI that includes at least one gamification element corresponding to the identified one or more financial goals of the user. The at least one gamification element may be used to provide an interactive experience with the user of client device 102, in an attempt to foster improved financial habits. For example, by providing the at least one gamification element, a user of client device 102 may be able to view progress associated with reaching a financial goal, in an attempt to show the user how improved savings habits can streamline a savings experience. The at least one gamification element may include at least one graphical element corresponding to the target of the financial goal (e.g., trip, one or more goods, one or more services, etc.) and at least a second graphical element corresponding to a user's progress towards satisfying that financial goal (e.g., progress bar of the financial goal). As a user's account receives debit account events (i.e., money leaving the account) and credit account events (i.e., money entering the account), the progress bar may dynamically change, thereby providing real-time (or near real-time) status changes of the financial goal. In some embodiments, goal manager 118 may provide a gamification element for each sub-part of the financial goal. For example, goal manager 118 may provide a progress bar for each sub-part thereof.

At step 410, organization computing system 104 may receive at least one account event associated with an account 124 from user profile 122. For example, organization computing system 104 may receive at least one of a credit account event or a debit account event. At step 412, organization computing system 104 may determine if the account event is a debit account event. For example, goal manager 118 may receive a debit account event from a third party merchant 106.

If, at step 412, organization computing system 104 determines that the account event is a debit account event, then method 400 proceeds to step 414. At step 414, organization computing system 104 may update the GUI to reflect the debit account event. For example, based on the amount of money leaving the user's account, goal manager 118 may update the gamification element accordingly. In some embodiments, updating the gamification element may include updating the graphical element reflecting the progress based on the debit account event. In some embodiments, updating the gamification element may include maintaining the current state of the progress bar.

If, however, at step 412, organization computing system 104 determines that the account event is not a debit account event (i.e., the account event is a credit account event), then method 400 proceeds to step 416. At step 418, organization computing system 104 may update the GUI to reflect the credit account event. For example, based on the amount of money entering the user's account (e.g., salary deposit), goal manager 118 may update the gamification element accordingly. In some embodiments, updating the gamification element may include updating the graphical element reflecting the progress based on the credit account event. Although a credit account event corresponds to money entering the user's account, those skilled in the art may readily understand that not all credit account events may result in the user's progression towards a financial goal.

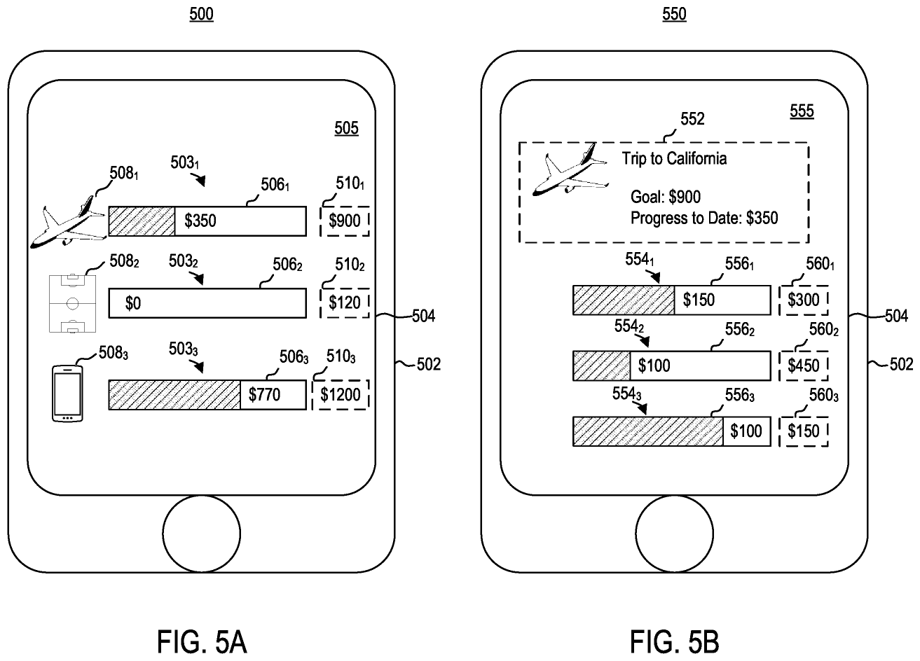

FIG. 5A is a block diagram 500 illustrating a GUI 505 displayed on client device 502, according to example embodiments. Client device 502 may be similar to client device 102. Client device 502 may include a display 504. GUI 505 may be displayed via display 504 associated with client device 502. GUI 505 may be accessed via application 112 executing thereon.

GUI 505 may include one or more gamification elements 503₁-503₃ (generally “gamification element 503”). Each gamification element 503 may correspond to a respective financial goal of a user. For example, gamification element 503₁ may correspond to a trip to California; gamification element 503₂ may correspond to tickets to a soccer match; and gamification element 503₃ may correspond to a new cell phone.

Each gamification element 503 may include one or more graphical elements. For example, each graphical element 503 may include a first graphical element 508, a second graphical element 506, and a third graphical element 510. Each first graphical element 508 may be representative of a symbol or identifier associated with a financial goal. For example, gamification element 503₁ may include first graphical element 508₁ that is an airplane; gamification element 503₂ may include a first graphical element 508₂ that is a soccer field; and graphical element 503₃ may include a third graphical element 508₃ corresponding to a cell phone.

Second graphical element 506 may be representative of a progress bar associated with a financial goal. For example, gamification element 503₁ may include second graphical element 506₁ corresponding to a progress bar for that illustrates a current savings amount of $350; gamification element 503₂ may include second graphical element 506₂ corresponding to a progress bar that illustrates a current savings amount of $0; and gamification element 503₃ may include a third graphical element 506₃ corresponding to a progress bar that illustrates a current savings amount of $770.

Graphical element 510 may be representative of a target savings amount for each financial goal. For example, gamification element 503₁ may include a third graphical element 510₁ corresponding to a target savings amount of $900; gamification element 503₂ may include a third graphical element 510₂ corresponding to a target savings amount of $120; and gamification element 503₃ may include a third gamification element 510₃ corresponding to a target savings amount of $1200.

FIG. 5B is a block diagram 550 illustrating a GUI 555 displayed on client device 502, according to example embodiments. Client device 502 may be similar to client device 102. Client device 502 may include a display 504. GUI 555 may be displayed via display 504 associated with client device 502. GUI 555 may be accessed via application 112 executing thereon.

GUI 555 may be representative of a detail view of a financial goal. For example, GUI 555 may be representative of a detailed view of gamification element 503₁ in FIG. 5A. GUI 555 may include at least graphical element 552. Graphical element 552 may represent one or more details of the selected gamification element from GUI 505. For example, graphical element 552 may recite: “Trip to California. Goal $900. Progress to Date: $350.” GUI 555 may further include one or more additional gamification elements 554₁-554₃ (generally “gamification element 554”). Each gamification element 554 may correspond to a respective category of spending associated with the financial goal of, for example, “Trip to California.” For example, gamification element 554₁ may correspond to a trip to Travel Expenses; gamification element 554₂ may correspond to Lodging Expenses; and gamification element 554₃ may correspond to a Food Expenses.

Each gamification element 554 may include one or more graphical elements. For example, each graphical element 554 may include a first graphical element 556 and a second graphical element 560. Each first graphical element 556 may be representative of a progress bar associated with a financial goal. For example, gamification element 554₁ may include first graphical element 556₁ corresponding to a progress bar that illustrates a current savings amount of $150; gamification element 554₂ may include first graphical element 556₂ corresponding to a progress bar that illustrates a current savings amount of $100; and gamification element 554₃ may include a first graphical element 556₃ corresponding to a progress bar that illustrates a current savings amount of $100.

Graphical element 560 may be representative of a target savings amount for each financial goal. For example, gamification element 554₁ may include a second graphical element 560₁ corresponding to a target savings amount of $300; gamification element 554₂ may include a second graphical element 560₂ corresponding to a target savings amount of $450; and gamification element 554₃ may include a second gamification element 560₃ corresponding to a target savings amount of $150.

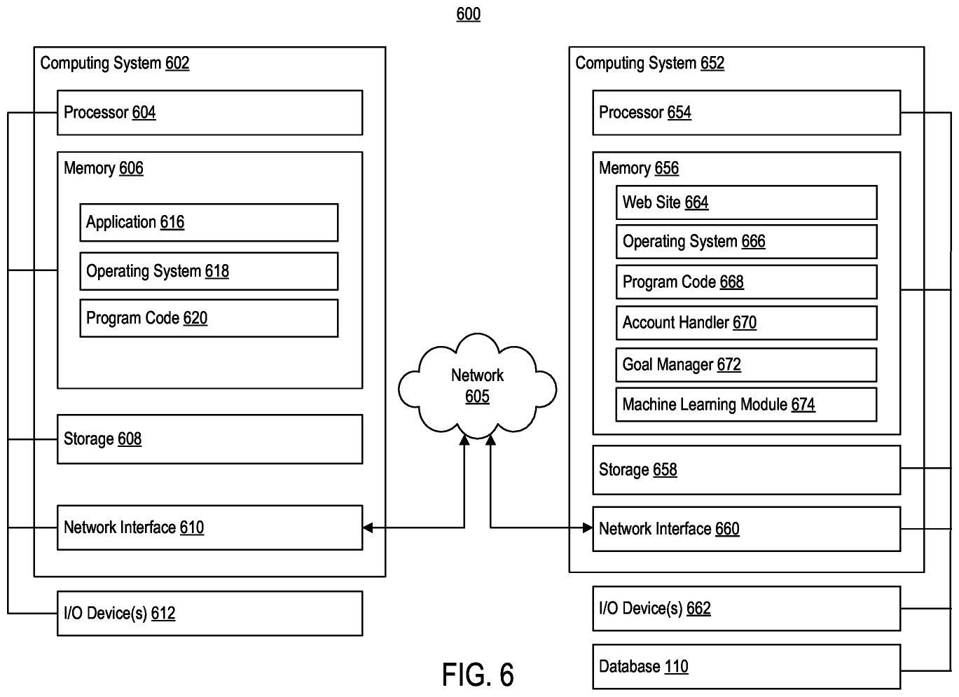

FIG. 6 is a block diagram illustrating an exemplary computing environment 600, according to some embodiments. Computing environment 600 includes computing system 602 and computing system 652. Computing system 602 may be representative of client device 102. Computing system 652 may be representative of organization computing system 104.

Computing system 602 may include a processor 604, a memory 606, a storage 608, and a network interface 610. In some embodiments, computing system 602 may be coupled to one or more I/O device(s) 612 (e.g., keyboard, mouse, etc.).

Processor 604 may retrieve and execute program code 620 (i.e., programming instructions) stored in memory 606, as well as stores and retrieves application data. Processor 604 may be included to be representative of a single processor, multiple processors, a single processor having multiple processing cores, and the like. Network interface 610 may be any type of network communications allowing computing system 602 to communicate externally via computing network 605. For example, network interface 610 is configured to enable external communication with computing system 652.

Storage 608 may be, for example, a disk storage device. Although shown as a single unit, storage 608 may be a combination of fixed and/or removable storage devices, such as fixed disk drives, removable memory cards, optical storage, network attached storage (NAS), storage area network (SAN), and the like.

Memory 606 may include application 616, operating system 618, program code 620, and geolocation agent 622. Program code 620 may be accessed by processor 604 for processing (i.e., executing program instructions). Program code 620 may include, for example, executable instructions for communicating with computing system 652 to display one or more pages of website 664. Application 616 may enable a user of computing system 602 to access a functionality of computing system 652. For example, application 616 may access content managed by computing system 652, such as website 664. The content that is displayed to a user of computing system 602 may be transmitted from computing system 652 to computing system 602, and subsequently processed by application 616 for display through a graphical user interface (GUI) of computing system 602.

Computing system 652 may include a processor 654, a memory 656, a storage 658, and a network interface 660. In some embodiments, computing system 652 may be coupled to one or more I/O device(s) 662. In some embodiments, computing system 652 may be in communication with database 110.

Processor 654 may retrieve and execute program code 668 (i.e., programming instructions) stored in memory 656, as well as stores and retrieves application data. Processor 654 is included to be representative of a single processor, multiple processors, a single processor having multiple processing cores, and the like. Network interface 660 may be any type of network communications enabling computing system 652 to communicate externally via computing network 605. For example, network interface 660 allows computing system 652 to communicate with computer system 602.

Storage 658 may be, for example, a disk storage device. Although shown as a single unit, storage 658 may be a combination of fixed and/or removable storage devices, such as fixed disk drives, removable memory cards, optical storage, network attached storage (NAS), storage area network (SAN), and the like.

Memory 656 may include website 664, operating system 666, program code 668, account handler 670, goal manager 672, and machine learning module 674. Program code 668 may be accessed by processor 654 for processing (i.e., executing program instructions). Program code 668 may include, for example, executable instructions configured to perform steps discussed above in conjunction with FIGS. 2-4. As an example, processor 654 may access program code 668 to perform operations for generating a dynamic GUI. In another example, processor 654 may access program code 668 to perform operations for generating one or more graphical elements for inclusion in a dynamic GUI. Website 664 may be accessed by computing system 602. For example, website 664 may include content accessed by computing system 602 via a web browser or application.

Goal manager 672 may be configured to identify and manage one or more financial goals of each user. In some embodiments, goal manager 672 may identify one or more financial goals of a user through an explicit conveyance of the financial goal from computing system 602 to computing system 652.

Machine learning module 674 may include one or more computer systems configured to train a prediction model used by goal manager 672. To train the prediction model, machine learning module 674 may receive, as input, one or more streams of user activity. The one or more streams of user activity may correspond to actions taken by the user with respect to the user's accounts. In some embodiments, machine learning module 674 may further receiver, as input, one or more streams of activity associated with additional users (e.g., users similar to the current user based on). As such, machine learning module 674 may leverage both user specific and user agnostic information to identify a particular financial goal and a cost associated with that financial goal. Machine learning module 674 may implement one or more machine learning algorithms to train the prediction model.

Account handler 670 may be configured to manage an account associated with each user. For example, account handler 670 may be configured to communicate with database 110.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. An account management system, comprising:
a processor in communication with a client device of a user; and
a memory having programming instructions stored thereon, which, when executed by the processor performs an operation, comprising:
identifying at least one financial goal of the user by:
analyzing one or more accounts of the user to identify one or more transactions;
identifying at least one product or service for which the user has transacted above a threshold number of times; and
setting the at least one product or service as the target savings amount for the at least one financial goal;
generating a target savings amount for the at least one financial goal by learning one or more spending habits of the user and one or more spending habits of other users unrelated to the user;
generating an estimated timeline for reaching the target savings amount by learning the one or more spending habits of the user;
generating a graphical user interface (GUI) comprising a first gamification element corresponding to the at least one financial goal and a second gamification element corresponding to the estimated timeline, the first gamification element and the second gamification element visually depicting progress towards the savings amount;
receiving at least one account event; and
updating the GUI by adjusting the first gamification element and the second gamification element in real-time to depict an updated progress towards the savings amount.

2. The account management system of claim 1, wherein identifying at least one financial goal of the user comprises:
receiving, from a remote client device, the at least one financial goal of the user.

3. (canceled)

4. The account management system of claim 1, wherein the at least one gamification element comprises a progress bar.

5. The account management system of claim 1, wherein generating the target savings amount for the at least one financial goal by learning one or more spending habits of the user and one or more spending habits of other users unrelated to the user, comprises:
adjusting the target savings amount based on the one or more spending habits of the one or more other users.

6. The account management system of claim 1, wherein generating the target savings amount for the at least one financial goal based on the at least one or more spending habits of the user comprises:
identifying a total cost associated with the at least one financial goal from one or more external data sources.

7. The account management system of claim 1, wherein the operation further comprises:
generating a recommendation message based on the received at least one account event; and
transmitting the recommendation message to the client device of the user.

8. The account management system of claim 1, wherein the received at least one account event comprises at least one of a debit from the user's account or a credit to the user's account.

9. The account management system of claim 1, wherein the gamification element comprises:
one or more sub-elements representative of one or more categories of spending associated with the financial goal.

10. A method of generating a dynamic graphical user interface, comprising:
receiving, at a computing system from a client, an indication of at least one financial goal of the user;
identify, by the computing system, one or more categories of spending associated with the financial goal;
generating, by the computing system, a target savings amount for the at least one financial goal by learning one or more spending habits of the user and one or more spending habits of other users unrelated to the user, the target savings amount comprising a category-level target savings amount for each of the one or more categories of spending;
generating, by the computing system, an estimated timeline for reaching the target savings amount by learning the one or more spending habits of the user;
generating, by the computing system, a graphical user interface (GUI) comprising a first gamification element corresponding to the at least one financial goal and a second gamification element corresponding to the estimated timeline, the first and second gamification elements visually depicting progress towards the savings amount;
receiving, at the computing system from at least one third party computing system, at least one account event; and
updating, by the computing system, the GUI by adjusting the first gamification element and the second gamification element in real-time to depict an updated progress towards the savings amount.

11. The method of claim 10, wherein generating, by the computing system, the GUI comprising the at least one gamification element corresponding to the at least one financial goal, the at least one gamification element visually depicting progress towards the savings amount, comprises:
generating at least one progress bar associated with the at least one gamification element.

12. The method of claim 11, wherein generating at least one progress bar associated with the at least one gamification element, comprises:
generating one or more category-level progress bars, each category-level progress bar corresponding to a category-level target savings amount.

13. The method of claim 10, wherein generating, by the computing system, the target savings amount for the at least one financial goal by learning one or more spending habits of the user and one or more spending habits of the other users unrelated to the user comprises:
adjusting the target savings amount based on the one or more spending habits of the one or more other users.

14. The method of claim 10, wherein generating the target savings amount for the at least one financial goal based on the at least one or more spending habits of the user comprises:
identifying a total cost associated with the at least one financial goal from one or more external data sources.

15. The method of claim 10, further comprising:
generating, by the computing system, a recommendation message based on the received at least one account event; and
transmitting, by the computing system, the recommendation message to the client.

16. The method of claim 10, wherein the received at least one account event comprises at least one of a debit from the user's account or a credit to the user's account.

17. A non-transitory computer readable medium comprising one or more sequences of instructions, which, when executed by one or more processors, cause the one or more processors to perform operations, comprising:
parsing a transaction history of a user to identify at least one financial goal of the user;
generating a target savings amount for the at least one financial goal based at least on one or more spending habits of the user by:
analyzing one or more accounts of the user to identify one or more transactions;
identifying at least one product or service for which the user has transacted above a threshold number of times; and
setting the at least one product or service as the target savings amount for the at least one financial goal;
generating an estimated timeline for reaching the target savings amount by learning the one or more spending habits of the user;
generating a graphical user interface (GUI) comprising a first gamification element corresponding to the at least one financial goal and a second gamification element corresponding to the estimated timeline, the first gamification element and the second gamification element visually depicting progress towards the target savings amount;
receiving at least one account event; and
updating the GUI by adjusting the first gamification element and the second gamification element to depict an updated progress towards the target savings amount.

18. The non-transitory computer readable medium of claim 17, wherein parsing the transaction history of the user to identify the at least one financial goal of the user comprises:
identifying at least one product or service for which the user has transacted above a threshold number of times.

19. The non-transitory computer readable medium of claim 17, wherein generating the target savings amount for the at least one financial goal based on the at least one or more spending habits of the user comprises:
identifying at least one or more spending habits of one or more other users; and
adjusting the target savings amount based on the at least one or more spending habits of one or more other users.

20. The non-transitory computer readable medium of claim 17, wherein generating the target savings amount for the at least one financial goal based on the at least one or more spending habits of the user comprises:
identifying a total cost associated with the at least one financial goal from one or more external data sources.
